(19) United States
(12) Patent Application Publication
(10) Pub. No.: US 2012/0318658 A1
(43) Pub. Date: Dec. 20, 2012

(54) DEVICE FOR DISTILLING VARIOUS KINDS OF WATER BY USING SOLAR HEAT, AND DISTILLATION METHOD

(76) Inventor: Jeong Ho Hong, Daegu (KR)

(21) Appl. No.: 13/582,450

(22) PCT Filed: Mar. 3, 2010
(86) PCT No.: PCT/KR2010/001306

§ 371 Date: Sep. 3, 2012

(51) Int. Cl. C02F 1/14; B01D 3/04

(52) U.S. Cl. 203/10; 202/153

(57) ABSTRACT

This invention is for the provision of water distillation device and the method using the solar heat.

More particularly, the solar heat distillation device comprises;
The solar heat collector with cylindrical parabolic reflective mirror which is formed with the fixed focus axis of reflection surface where the sun light is concentrated by the reflection and the cylindrical parabolic reflective mirror is able to track the sun by revolving east to west around fixed axis of reflection surface;
And the expansion water pipe line on the focus axis which expand water by solar heating; and the condensation water tank on the focus axis of reflection surface which condensate the expanded water from the expansion water pipe line; also the evaporation water tank on the focus axis of reflection surface which generate steam by heating the water in the evaporation water tank with solar heat and high temperature steam;
And the steam reheating pipe line on the axis of reflection surface which provide high temperature steam by heating the steam from the evaporation water tank with solar heat;
With the above solar heat distillation device, it is characterized that comprises;
The heat exchanger which perform heat exchange between the water to distill and the distilled water for preheating the water to distill and cooling the distilled water; and the hand pump to fill water in the solar heat device at the initial operation.

Accordingly, this invention is complex process of pumping, heat exchanging, steam reheating and evaporation to distill seawater or all sorts of water in high efficiency by means of only with solar energy without any energy such as oil or electricity.

### TECHNICAL FIELD

The present invention relates to distillation device and method to distill all sorts of water such as seawater or waste water (hereinafter called as “water”) by means of utilization of solar heat.

More particularly, from the high performance solar heat collectors such as cylindrical parabolic reflective mirror in the solar heat collectors, let the focus axis of the reflection surface is fixed and compose solar heat collector with the cylindrical parabolic reflective mirror which is able to track the sun by revolving east to west around fixed axis of solar heat collector.

Install the expansion water pipe line and the condensation water tank on the fixed bar at focus axis of reflective surface of solar heat collector in above, then let the water in the expansion water pipe line be heated by solar heat to make volume expansion, and then condense water from the expansion water pipe line with the water in the condensation water tank to make volume contraction. This action will provide to perform function of heating and supplying of water to the evaporator at the same time when the expansion water pipe line and the condensation water tank are composed as in above.

For forming the solar heat distillation device, install the evaporation tank and the steam reheating pipe line on the fixed bar at focus axis of reflective surface, then let steam generated from the evaporator is reheated by solar heat to raise the steam temperature, which steam will be reused together with solar heat to heat the water in the evaporator so the latent heat of steam is effectively reused for distillation.

With above solar heat distillation device, install the heat exchanger and the hand pump so the low temperature water inflow into evaporator is preheated and high temperature distilled water emitted from evaporator is cooled. The evaporator in above is related to the distillation device and method for all sorts of water including seawater with the multi-functions such as pumping, reheating the steam and evaporation only with solar heat and heat exchanging.

### BACKGROUND ART

The conventional technologies of distillation or evaporation have been typically Multi-Effect Distillation system, Multi-Stage Flashing and Mechanical Vapor Recompression method.

The water in conventional evaporation systems is heated by steam for evaporation and the generated steam is reused as heat source and the other hand, these system have the problem as the steam temperature is getting lower and lower when it passing each stage of evaporators.

To evaporate water with low temperature steam, the pressure in evaporation chamber should be reduced by use of the decompression pump for evaporation at low temperature.

Because of this reason, electric power expenses for decompression and expenses for auxiliary facilities and increment of operation cost are the problems.

Mechanical Vapor Compression method is also in the same situation for steam recompression.

### DISCLOSURE OF INVENTION

### Technical Problem

Therefore, the purpose of this invention is to provide distillation device and method without any cost for operation by using solar heat with low cost of installation.

Also, the other purpose of this invention is to provide high efficient distillation device and method by means of utilization only with solar heat which comprise the units of multi-function such as the function of expansion and condensation of water and the function of reheating the steam and evaporation of water on the fixed bar at focus axis of reflective surface of solar heat collector.

### Technical Solution

In order to accomplish the above object, the solar heat collector with the cylindrical parabolic reflective mirror is provided to collect solar heat with the functional units at focus axis of reflective surface;

On the fixed bar at focus axis of above solar heat collector; Place the cylindrical condensation water tank, which intake water from outside;

And place the expansion water pipe line, which is heated by solar heat to expand water from condensation tank;

And place the condensation water pipe line in the cylindrical condensation water tank, which perform heat exchange between water/vapor from the expansion pipe line and water in the cylindrical condensation water tank;

And place the cylindrical evaporation water tank, which generate steam by solar heating the water fed from the condensation water pipe line;

And place the steam reheating pipe line to provide high temperature steam to the cylindrical evaporation water tank by heating the steam with solar heat;

And place the heating steam pipe line, which allow the high temperature steam from the steam reheating pipe line to use for heat source of evaporation.

After high temperature steam is used at the heating steam pipe line, the high temperature steam will change into the state of distilled water.

The solar heat distillation is accomplished by the solar heat collector with the cylindrical parabolic reflective mirror and is characterized to contain all the functional units described in above.

It is also characterized to include supporting rod for the functional units placed on the fixed bar at focus axis of reflective mirror.

It is also characterized to install the check valves between drain pipe of the cylindrical condensation water tank and one end of the expansion water pipe line, and between the other end of the expansion water pipe line and one end of the condensation water pipe of the cylindrical condensation water tank, and between the other end of the condensation water pipe of the cylindrical condensation water tank and the cylindrical evaporation water tank to control the direction of water flow.

It is also characterized that the surface of the cylindrical condensation water tank, the expansion water pipe line, the evaporation water tank, and the steam reheating pipe line are all treated to black surface for better solar heat absorption.

It is also characterized that the expansion water pipe line and steam reheating pipe line are installed as spiral winding around fixed bar on the focus axis of reflective surface.

It is also characterized that the pump supplying water into the condensation water tank in the beginning of operation;

And water pipe line from the pump to the condensation water tank;

And including the heat exchanger which exchange the heat between water inflow into the condensation water tank and distilled water from the heating steam pipe line.

Also, according to the other field of this invention, the above purpose is the step to provide the cylindrical parabolic reflective mirror type solar heat collector which is placed on the focus axis of reflective mirror to accept focused solar light by reflection;

And the step to heat and expand the water in the expansion water pipe line on the focus axis of reflective surface with solar heat;

And the step to condense water from the expansion water pipe line through the condensation water pipe line in the cylindrical condensation water tank on the focus axis of reflective surface;

And the step to generate steam from the water in the evaporation water tank on the focus axis of reflective surface by heating with solar heat;

And the step to provide high temperature steam from the steam reheating pipe line on the focus axis of reflective surface by heating with solar heat;

And the step to produce distilled water from the heating steam pipe line when the high temperature steam from the steam reheat pipe line is fed to the heating steam pipe line and is used to generate steam in the evaporation water tank. Then steam in the heating steam pipe line will be changed to distilled water;

In addition to the above, it is characterized that the step to make heat exchange between the water supplied to the condensation water tank and distilled water from the heating steam pipe line.

### Advantageous Effects

Through this invention, the invention in above is possible to substitute for the conventional evaporation devices which require high evaporation cost due to use of artificial energies and operation manpower.

This invention is able to distill all sort of water including seawater and waste water only with small quantity of solar heat and with no operation cost.

This invention is able to use for desalination and also waste water treatment where adequate water is not available. And also economic effect is expected.

### DESCRIPTION OF DRAWING

FIG. 1: Front View of Entire Water Distillation Device by using Solar Heat

FIG. 2: A1-A2 Cross Section of FIG. 1,

FIG. 3: B1-B2 Cross Section of FIG. 1,

FIG. 4: C1-C2 Cross Section of FIG. 1,

FIG. 5: D1-D2 Cross Section of FIG. 1,

FIG. 6: Floor Plan of FIG. 1,

FIG. 7: Right Side View of FIG. 1,

FIG. 8: Left Side View of FIG. 1

### DESCRIPTION OF PART NUMBER

1: Solar-heat Evaporation Device
2: Dual Pipe Type Heat Exchanger
3: Hand Pump
4: Water Supply Tank
5: Distilled Water Collection Tank
10: Tempered Glass
11: Side Plate of Cylindrical Parabolic Reflective Mirror
12: Cylindrical Parabolic Reflective Mirror
13: Supporting Rod of Solar Heat Evaporation Device
14: Expansion Water Pipe Line
15: Cylindrical Condensation Water Tank
16: Cylindrical Evaporation Water Tank
17: Steam Reheating Pipe line
18: Rotation Driving Axis
21: Inner Pipe of Heat Exchanger
22: Outer pipe of Heat Exchanger
31: Pump Cylinder
101, 102, 103, 302, 303: Check Valve
104: Exhaust Valve
105: Steam Trap
111: Fixed Side Plate of Supporting Rod
112: Coupling Rail for Side Plate of Parabolic Reflective Mirror
131: Strut of Solar Heat Evaporation Device
151: Condensation Water Pipe Line
152: Drain Pipe of Condensation Water Tank
161: Heating Steam Pipe Line
162: Drain Pipe for Water Level Control
163: Steam Chamber
181: Hanger of Driving Axis
301: Lock Valve
601, 602, 603, 604, 605, 606, 607: Water Pipe Line
   a: Inlet of Outer Pipe of Heat Exchanger
   b: Outlet of Outer Pipe of Heat Exchanger
   c: Inlet of Inner Pipe of Heat Exchanger
   d: Outlet of Inner Pipe of Heat Exchanger
   e: Cylinder Exhaust Hole

### BEST MODE

According to the attached drawings, the detailed explanation is as follows:

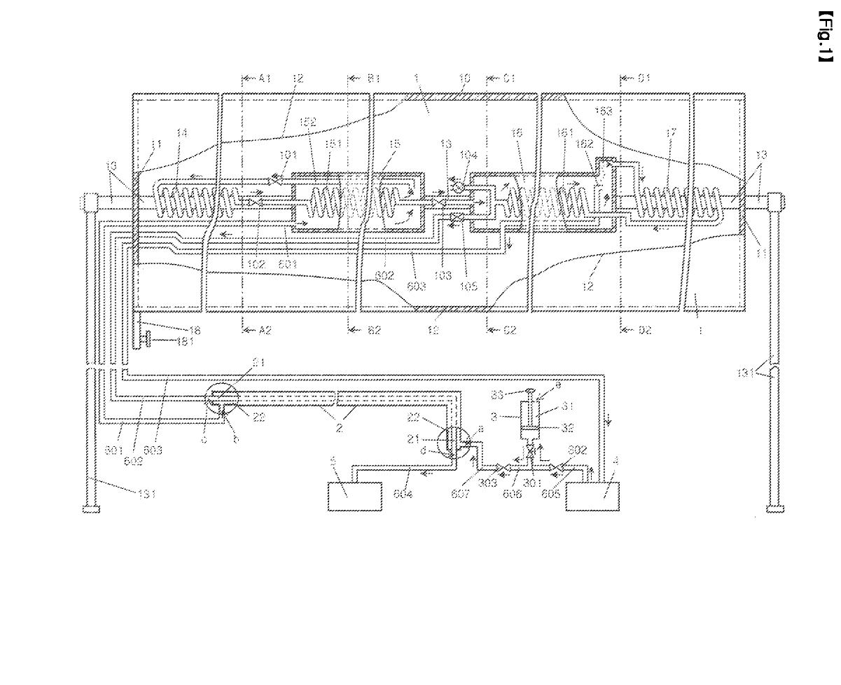

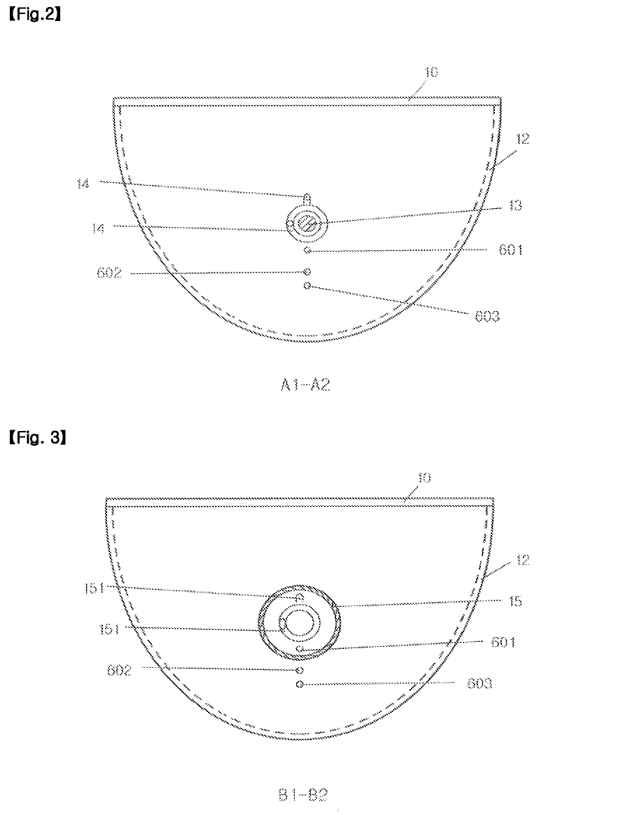

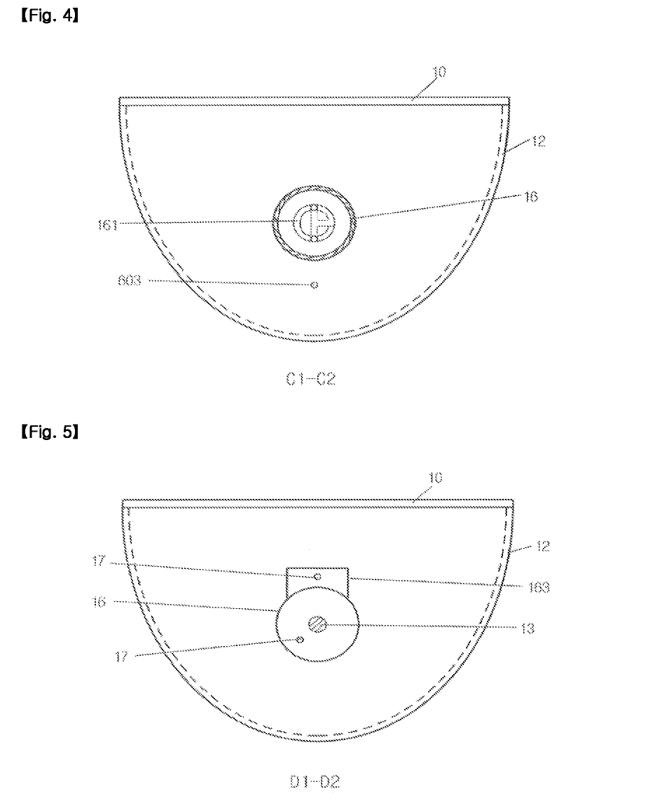

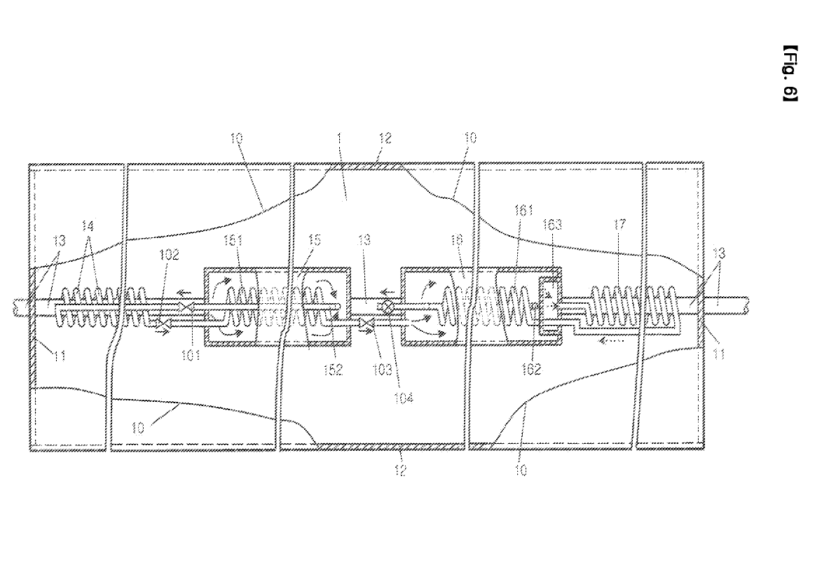

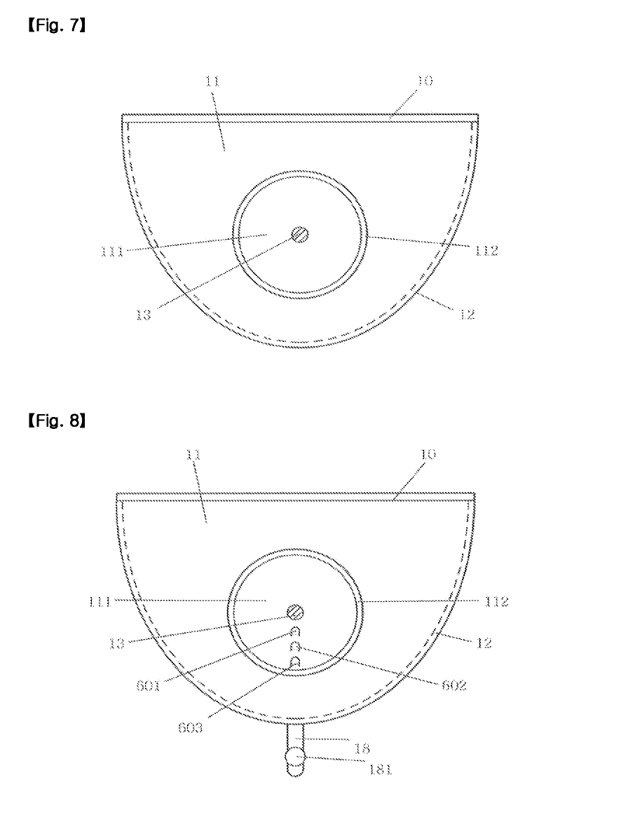

FIG. 1 is the representative drawing showing entire composition factors of this invention. The main composition factors of this invention are consist of the reflective mirror with structure of tracing the sun by revolving from east to west, and the evaporation device which contain functions of water expansion, water condensation, evaporation and steam reheating at the focus axis of reflective mirror by solar heating, and the heat exchanger which make heat exchange between water inflow into evaporation device and distilled water discharged from the evaporation device, and the hand pump for water supply at initial operation.

Solar heat collecting method of distillation device is utilizing the solar heat collector with solar light reflective surface which is able to collect high temperature solar heat. Existing commercial type solar heat collectors are the solar heat collector with cylindrical parabolic reflective mirror, PTC (Parabolic Trough Concentration) type and CPC (Compound Parabolic Concentration) type, however, in this invention, the solar heat collector with cylindrical parabolic reflective mirror is adopted, and the dual pipe type exchanger is adopted.

As shown on FIG. 1, the main composition of this invention is to distill water by solar heating in combination with the solar heat distillation device (1) which contain function of water expansion, condensation, evaporation and steam reheating on the focus axis of reflection surface, and heat exchanger (2), hand pump (3), water supply tank (4) and distilled water storage tank (5).

More particularly, the above solar heat distillation device (1) compose the cylindrical parabolic reflective mirror (12) which reflect solar light to the focus axis of reflective surface and track the sun by revolving east to west around fixed axis of solar heat collector, and solar heat absorbers on the focus axis of reflective surface which contain the expansion water pipe line (14), the cylindrical condensation water tank (15), the cylindrical evaporation water tank (16) and steam reheating pipe line (17) on the supporting rod of solar heat distillation device (13) which is fixed on the focus axis of reflective mirror.

Compose the solar heat distillation device (1) with the cylindrical parabolic reflective mirror (12) which provide tempered glass (10) on the aperture of the cylindrical parabolic reflective mirror (12) so as to pass through the short wavelength of light into the tempered glass (10) on aperture of cylindrical parabolic reflective mirror (12) while the long wavelength of infrared radiated from the solar heat absorbers on the focus axis is blocked by the tempered glass (10) to prevent heat loss. (Hereinafter “the cylindrical parabolic solar heat collector” (1) shall be referred as “solar heat collector, or simply, as “evaporation Device”)

More particularly, both end side of supporting rod (13) of solar heat distillation device (1) is installed and fixed on both side struts (131) at the focus axis, and side plates of the cylindrical parabolic reflective mirror (11) on the both sides of cylindrical parabolic reflective mirror (12) shall be coupled with fixed side plates of supporting rod (111) so compose the solar heat distillation device as the cylindrical parabolic reflective mirror (12) is able to revolve around the fixed supporting rod (13) on the focus axis of reflection surface,

On the fixed supporting rod (13) at the focus axis of reflection surface of the solar heat distillation device (1), install the expansion water pipe line (14) treated as black surface, and install the cylindrical condensation water tank (15) treated as black surface which contain the condensation water pipe line (151) and the drainage pipe of condensation water tank (152).

On both sides and in the middle between the expansion water pipe line (14) and the condensation water pipe line (151), couple each check valves (101), (102), (103) to control direction of water flow, and compose water from the cylindrical condensation water tank (15) to flow into the expansion water pipe line (14) by coupling the check valve (101) between the drainage pipe of condensation water tank (152) and the expansion water pipe line (14).

As composed in above, the expansion water pipe line (14) and the cylindrical condensation water tank (15) are composed for heating and supplying water by water expansion effect of the expansion water pipe line (14) and water condensation effect of the cylindrical condensation water tank (15).

Also on the fixed supporting rod (13) at the focus axis of the solar heat distillation device (1), install the cylindrical evaporation water tank (16) treated as black surface, and also steam reheating pipe line (17) treated as black surface.

On upper side of end part of the cylindrical evaporation water tank (16), compose the steam chamber, and install the heating steam pipe line (161) connected to the exhaust valve (104) and the steam trap (105), and the drain pipe for water level control (162) in the cylindrical evaporation water tank (16).

The steam chamber (163) on upper side of end part of the cylindrical evaporation tank (16) and the heating steam pipe line (161) in the cylindrical evaporation water tank (16) are coupled on each side of the steam reheating pipe line (17).

As the composition in above, the expansion water pipe line (14) and the cylindrical condensation water tank (15) have the functions of heating water, pumping and supplying water, and the cylindrical evaporation water tank (16) and steam reheating pipe line (17) provide heating the water in the cylindrical evaporation water tank (16) with solar heat and high temperature steam supplied into the heating steam pipe line (161) for reusing the latent of steam.

There are various way to install the expansion water pipe line (14), the condensation water pipe line (151), the heating steam pipe line (161), and reheat steam pipe line (17). However, in this invention, the surfaces of the expansion water pipe line (14), the cylindrical condensation water tank (15), the cylindrical evaporation water tank (16) and steam reheating pipe line (17) are treated as black surface to be able to absorb most solar heat.

In the method of installation, the expansion water pipe line (14) and the steam reheating pipe line (17) is wound spirally around the fixed support rod (13) with metal pipe treated as black surface, and the condensation water pipe line (151) and the heating steam pipe line (161) are also installed inside of cylindrical condensation water tank (15) and the cylindrical evaporation water tank (16) respectively by winding spirally around the fixed support rod (13) with metal pipes, which is the representative method in this invention.

The heat exchanger (2) is composed among the solar heat distillation device (1) in above and the water supply tank (4) and the distilled water collection tank (5) to exchange the heat between high temperature distilled water discharged from the distillation device (1) and low temperature water from the water supply tank (5), it is characterized to compose the hand pump (3) to fill the water into the expansion water pipe line (14), the condensation water pipe line (151), the cylindrical condensation water tank (15) and the cylindrical evaporation water tank (16) at initial operation of the solar heat distillation device (1).

As composed in above, the operation principle of this invention is as follows:

In case the solar heat distillation device (1) is operated in the method of solar tracking system, the driving axis is coupled to the hanger of driving axis (181) of the rotation driving axis (18) on the cylindrical parabolic reflective mirror (12), and in case of fixed method of operation is used, the aperture of the solar heat distillation device (1) is fixed perpendicularly. The solar heat evaporation device (1) provide only a part of the solar tracking function and the solar tracking device is excluded in this invention.

As shown in above, when all compositions of solar heat distillation device (1) are completed, at the initial operation, operate the hand pump (3) to fill the water into the cylindrical condensation water tank (15), the expansion water pipe line (14), the condensation water pipe line (151) than the cylindrical evaporation water tank (16) in order.

After water is filled up, the over flow water will be discharged through the drain pipe for water level control (162) in the cylindrical evaporation water tank (16). Then stop the operation of the hand pump (3) and close the valve (301).

The filling process of water for distilling is as follows:

As the handle is pulled out at first, the check valve (303) is closed and the check valve (302) is opened, then the water start to flow through water line (605), check valve (302) and lock valve (301) then into the pump cylinder (31) from the water supply tank (4).

As the handle is pushed in, the check valve (302) is closed and check valve (303) is opened to make water flow to the direction of the solar heat distillation device (1) from the pump cylinder (31). The cylinder exhaust hole (e) provides air ventilation for proper pump operation.

The course of water flow from the water supply tank (4) is flowing through the water pipe line (605), the check valve (302), the water pipe line (606), the lock valve (301), the pump cylinder (31), the lock valve (301), the water pipe line (606), the check valve (303), the water pipe line (607), the inlet of outer pipe of heat exchanger (a), the outer pipe of heat exchanger (22), the outlet of outer pipe of heat exchanger (b), the water pipe line (601), the cylindrical condensation water tank (15), the drain pipe of condensation water tank (152), the check valve (101), the expansion water pipe line (14), the check valve (102), the condensation water pipe line (151), the check valve (103) and the cylindrical evaporation water tank (16) in order.

When water is completely filled in the cylindrical evaporation water tank (16), the overflowed water is fed back to the water supply tank (5) through the drain pipe of water level control (162) and water pipe line (603).

As the above, when water is filled in solar heat evaporation device (1), the process of evaporation is as follows:

When the solar heat distillation device (1) on the focus axis start to receive sun light directly from the sun and from reflection sun light by the cylindrical parabolic reflective mirror (12), then all of the expansion water pipe line (14), the cylindrical condensation water tank (15), the cylindrical evaporation water tank (16) and steam reheating pipe line (17) on the focus axis are started heating by solar heat in the sun light.

When the water in the expansion water pipe line (14) is heated enough with solar heat, then steam is generated and the steam will cause the volume expansion and the increase of pressure in the expansion water pipe line (14). The increase of pressure in the expansion water pipe line (14) cause to push the water and steam in the expansion water pipe line (14) to flow into the condensation water pipe line (151) in the cylindrical condensation water tank (15), in the cylindrical evaporation water tank and through check valves (101) (102) (103) by the actions of the check valves (101) to close and (102) and (103) to open.

The water and steam flowed into the condensation water pipe line (151) is condensed by the water in the cylindrical condensation water tank (15), and the volume of the water and steam in the condensation water pipe line (151) are contracted because of decrease of pressure in the condensation water pipe line (151). The decrease of pressure in the expansion water pipe line (14) which create contractible force to pull in the water from the expansion water pipe line (14) and the drain pipe of condensation water tank (152) in the cylindrical condensation water tank (15) to flow into the condensation water pipe line (151) in the cylindrical condensation water tank (15) through check valves (101), (102), (103) by the actions of the check valves (101) and (102) to open and (103) to close.

When the above processes are repeated, water in the expansion water pipe line (14) is expanded to make the check valve (101) on the side of the drain pipe of condensation water tank (152) is closed, and the check valve (102) on the side of the expansion water pipe (14) and check valve (103) on the side of the cylindrical evaporation water tank (16) are opened, and the water in the expansion water pipe line (14) flow into the cylindrical evaporation water tank (16) through condensation water pipe (151).

When the water and steam in the condensation water pipe line (151) are condensed, the check valve (101) on the side of the drain pipe of the condensation water tank (152) and the check valve (102) on the side of the expansion water pipe line (14) are opened, and the check valve (103) on the side of the cylindrical evaporation water tank (16) are closed, and the water flow into the expansion water pipe line (14) through check valve (101) on the side of the drain pipe of the condensation water tank (152).

As in above, the actions of expansion and condensation of the expansion water pipe line (14) and the condensation water pipe line (15) provide the functions of pumping and supplying water into the cylindrical evaporation water tank (16).

Generally, when water is boiled to generate steam, the volume of steam is expanded about 1,600 times so the expansion pressure is created which provide pushing force, on the contrary, when steam is condensed, the volume is contracted by 1/1,600 so decrease of pressure create contractible force which provide pulling force, these are the method of pumping using the phenomenon of expansion and contraction.

As in above, when the water supplied into the cylindrical evaporation water tank (16), then the water in the cylindrical evaporation water tank (16) is heated and evaporated by the solar heat.

The generated steam is gathered together in the steam chamber (163) and supplied to the steam reheating pipe line (17). The steam in the steam reheating pipe line (17) is heated by solar heat to raise the steam temperature which is supplied to the heating steam pipe line (161) to use for evaporation heat source in the cylindrical evaporation water tank (16).

Now, the water in the cylindrical evaporation water tank (16) is heated with the solar heat together with the reheated high temperature steam in the heating steam pipe line (161) to expedite the evaporation rapidly.

The steam used for heat source of evaporation is condensed after being used for evaporation of water, then the steam is condensed to distilled water which is discharged into the distilled water collection tank (5) passing through the steam trap (105), the water pipe line (602), the inlet of inner pipe of heat exchanger (c), the inner pipe of heat exchanger (21), the outlet of inner pipe of heat exchanger (d) and the water pipe line (604).

Now, the exhaust valve (104) removes the air contained in the steam. To improve heat efficiency, the water flowing into the solar heat distillation device (1) and the distilled water discharged from the solar heat evaporation device (1) are heat exchanged to obtain the water to distill is preheated and the distilled water discharged from the evaporation device is cooled.

Accordingly, this invention is characterized to provide the solar heat evaporation device with the functions of water pumping, steam reheating and evaporation, and the high efficiency methods of distillation for all sorts of water including seawater by using only with solar heat.

1. The solar heat collector with the cylindrical parabolic reflective mirror which forming focus axis where the sun light reflection is focused;
And the condensation water tank where water inflow from outside is placed on the focus axis of solar heat collector;
And the expansion water pipe line is placed on the focus axis of solar heat collector; and the water from the condensation water tank is heated at the expansion water pipe line with solar heat to make water expansion;
And the condensation water pipe line is installed in the condensation water tank to condensate the expanded water from the expansion water pipe line with the water in the condensation water tank;
And the evaporation water tank is placed on the focus axis of solar heat collector, and the water from the condensation water pipe line is used to generate steam in the evaporation water tank with solar heat;
And the steam reheating pipe line is placed on the focus axis of solar heat collector, and the steam from the evaporation tank is reheated with solar heat to provide high temperature steam in the steam reheating pipe line;
And the heating steam pipe line is installed in the evaporation water tank so the high temperature steam supplied to the heating steam pipe line which is used as a evaporation heat source in the evaporation water tank, the solar heat distillation device characterizing also to include the heating steam pipe line which provide additional heat source beside solar heat for evaporation.

2. Regarding claim 1,
The solar heat distillation device is characterized to include the fixed supporting rod to support the condensation water tank, the expansion water pipe line, the evaporation water tank and the heating steam pipe line on the focus axis of solar heat collector.

3. Regarding claim 1,
The solar heat distillation device is characterized to include each check valves coupled between the drain pipe of condensation water tank and the expansion water pipe line, and between the expansion water pipe line and the condensation water pipe line, and between the condensation water pipe line and the evaporation water tank.

4. Regarding claim 1,
The solar heat distillation device is characterized that the condensation water tank, the expansion water pipe line, the evaporation water tank and the steam reheating pipe line are treated as black surface.

5. Regarding claim 2,
The solar heat distillation device is characterized that the expansion water pipe line and the steam reheating pipe line are installed as spiral winding around the fixed supporting rod.

6. Regarding claim 1,
The solar heat distillation device is characterized also to include the pump which supplying water into the condensation water tank from outside; and the water pipe line leading the discharged water from the pump to the condensation water tank; and the heat exchanger which exchange the heat between the water supply to the condensation water tank and the distilled water from the heating steam pipe line.

7. The step to provide the solar heat collector with cylindrical parabolic reflective mirror which form the focus axis of reflection surface where the sun light is focused by reflection;
And the step for heating and expanding the water in the expansion water pipe line on the focus axis with solar heat;
And the step to heating and condensate the expanded water from the condensation water tank through the condensation water pipe line in condensation water tank on the focus axis;
And the step to generate steam from the evaporation water tank by heating the water inflow from the condensation water pipe line with solar heat.
And the step to provide high temperature steam by reheating the steam from the evaporation water tank through the steam reheating pipe line on the focus axis which is reheated with solar heat;
The solar heat distillation method also include the step that the high temperature steam from the steam reheating pipe line is used for evaporation heat source through the heating steam pipe line in the evaporation water tank and produce distilled water after the high temperature steam is used for evaporation.

8. Regarding claim 7,
The solar heat distillation method is characterized also to include the step to make heat exchange between the water supplied to the expansion water pipe line and distilled water from the heating steam pipe line.
